(19) United States
(12) Patent Application Publication
(10) Pub. No.: US 2025/0373119 A1
(43) Pub. Date: Dec. 4, 2025

(54) ROTARY ELECTRIC MACHINE

(71) Applicant: DENSO CORPORATION, Kariya-city (JP)

(72) Inventors: SEIGO SHINODA, Kariya-city (JP); TOSHINORI OCHIAI, Kariya-city (JP)

(21) Appl. No.: 19/299,106

(22) Filed: Aug. 13, 2025

Related U.S. Application Data
(63) Continuation of application No. PCT/JP2024/003606, filed on Feb. 5, 2024.

(30) Foreign Application Priority Data
Feb. 17, 2023 (JP) 2023-023231

(51) Int. Cl. H02K 9/06; B64C 29/00; B64D 27/30; H02K 21/24

(52) U.S. Cl. CPC H02K 9/06; B64C 29/0033; B64D 27/30; H02K 21/24

(57) ABSTRACT

A rotary electric machine is driven by a supply of electric power. The rotary electric machine includes a stator and a rotor. The rotor rotates about a rotation axis, and faces the stator through an axial gap in an axial direction in which the rotation axis extends. The rotor includes vanes provided inward of the axial gap in a radial direction of the rotation axis, and the vanes send gas toward the axial gap according to rotation of the rotor.

### CROSS REFERENCE TO RELATED APPLICATIONS

The present application is a continuation application of International Patent Application No. PCT/JP2024/003606 filed on Feb. 5, 2024, which designated the U.S. and claims the benefit of priority from Japanese Patent Application No. 2023-023231 filed on Feb. 17, 2023. The disclosures of all the above applications are incorporated herein.

### TECHNICAL FIELD

The disclosure in this specification relates to a rotary electric machine.

### BACKGROUND ART

In an axial gap motor, a rotor and a stator are aligned in an axial direction. In the motor, the rotor and the stator are accommodated in a motor housing.

### SUMMARY

According to an aspect of the present disclosure, a rotary electric machine is configured to be driven by a supply of electric power. The rotary electric machine includes a stator and a rotor. The rotor is configured to rotate about a rotation axis, and faces the stator through an axial gap in an axial direction in which the rotation axis extends. The rotor includes vanes provided inward of the axial gap in a radial direction of the rotation axis, and configured to send gas toward the axial gap according to rotation of the rotor.

### BRIEF DESCRIPTION OF THE DRAWINGS

The details of one or more embodiments are set forth in the accompanying drawings and the description below. Other features and advantages will be apparent from the description and drawings, and from the claims.

FIG. 1 is a diagram illustrating a configuration of an eVTOL according to a first embodiment.

FIG. 2 is a diagram illustrating an electrical configuration of a propulsion system.

FIG. 3 is a schematic perspective view of an EPU.

FIG. 4 is a vertical cross-sectional view of a motor device.

FIG. 5 is a perspective view of a first rotor.

FIG. 6 is a vertical cross-sectional view of a motor device.

FIG. 7 is a schematic vertical cross-sectional view of an interposed partition portion and its surrounding components in the motor device.

FIG. 8 is a top view of a holder fixed portion inside the motor device.

FIG. 9 is a schematic vertical cross-sectional view of an interposed partition portion and its surrounding components in a motor device according to a second embodiment.

FIG. 10 is a top view of a holder fixed portion inside a motor device according to a third embodiment.

### DETAILED DESCRIPTION

According to a comparative example, an axial gap motor includes a rotor and a stator aligned in an axial direction. In the motor, the rotor and the stator are accommodated in a motor housing.

However, in the comparative example, it is considered that heat is likely to be accumulated between the rotor and the stator. When the heat is accumulated between the rotor and the stator, there is a concern that a temperature of the motor excessively rises.

In contrast, according to the present disclosure, a rotary electric machine is capable of enhancing a cooling effect.

According to a disclosed aspect, a rotary electric machine is configured to be driven by a supply of electric power. The rotary electric machine includes a stator and a rotor. The rotor is configured to rotate about a rotation axis, and faces the stator through an axial gap in an axial direction in which the rotation axis extends. The rotor includes vanes provided inward of the axial gap in a radial direction of the rotation axis, and configured to send gas toward the axial gap according to rotation of the rotor.

According to the above aspect, the vanes are provided radially inward of the axial gap, and send gas toward the axial gap according to rotation of the rotor. In this configuration, when the rotor rotates according to driving of the rotating electric machine, the gas sent from the vanes passes through the axial gap. Thus, heat generated in the stator and rotor is likely to be released radially outward of the axial gap together with the gas. Therefore, the vanes of the rotor can prevent heat from accumulating in the axial gap. Accordingly, a cooling effect of the rotary electric machine can be improved.

Hereinafter, embodiments for implementing the present disclosure are described referring to drawings. In each embodiment, the same reference numerals may be given to parts corresponding to matters described in a preceding embodiment, and overlapping explanations may be omitted. When only a part of a configuration is described in an embodiment, the other preceding embodiments can be applied to the other parts of the configuration. It may be possible not only to combine parts which are explicitly described in the embodiments to be able to be combined specifically, but also to partially combine the embodiments without such explicit description unless there is a problem with the combination.

### First Embodiment

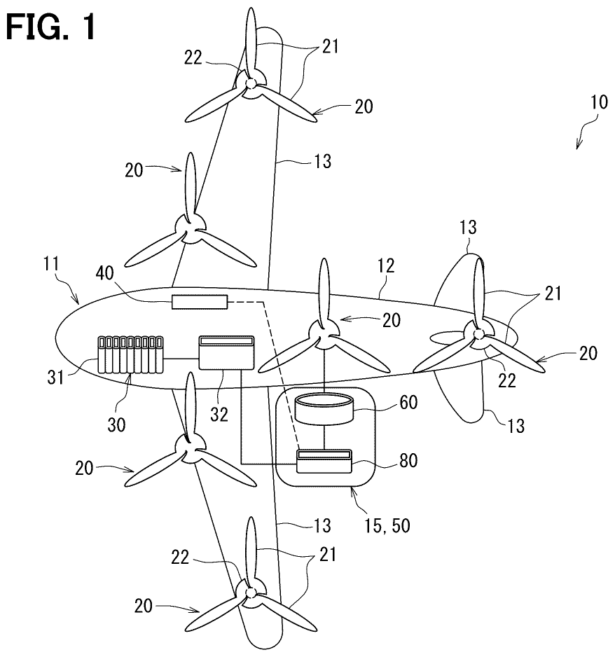

A propulsion system 30 shown in FIG. 1 is mounted in an eVTOL 10. The eVTOL 10 is an electric vertical take-off and landing aircraft, and can take off and land in a vertical direction. The eVTOL is an abbreviation of an electric vertical take-off and landing aircraft. The eVTOL 10 is an aircraft flying in the atmosphere and corresponds to a flight vehicle. The eVTOL 10 is also an electric-type electric aircraft and may be referred to as an electric flight vehicle. The eVTOL 10 is a manned aircraft carrying occupants. The propulsion system 30 is a system that drives the eVTOL 10 to fly.

The eVTOL 10 includes an airframe 11 and propellers 20. The airframe 11 includes an airframe main body 12 and wings 13. The airframe main body 12 is a body of the airframe 11 and has, for example, a shape extending in a front-rear direction. The airframe main body 12 has a passenger compartment for carrying occupants. Each of the wings 13 extends from the airframe main body 12 and multiple wings 13 are provided on the airframe main body 12. The wings 13 are fixed wings. The multiple wings 13 include a main wing, a tail wing, and the like.

The propellers 20 are provided on the airframe 11. The eVTOL 10 is a multicopter including at least three propellers 20. For example, at least four propellers 20 are provided on the airframe 11. The propellers 20 are provided on the airframe main body 12 and the wings 13. Each of the propellers 20 rotates around a propeller axis. The propeller axis is, for example, a center axis of a propeller 20. The propellers 20 can generate thrust and lift in the eVTOL 10. The propellers 20 may be referred to as rotors or rotary wings.

Each of the propellers 20 includes blades 21 and a boss 22. The blades 21 are arranged in a circumferential direction of the propeller axis. The boss 22 couples the multiple blades 21. Each of the blades 21 extends from the boss 22 in a radial direction of the propeller axis. Each of the propellers 20 includes a propeller shaft (not shown). The propeller shaft is a rotary shaft of each propeller 20 and extends along the propeller axis from the boss 22.

The eVTOL 10 is a tilt-rotor aircraft. In the eVTOL 10, tilt angles of the propellers 20 are adjustable. The eVTOL 10 may not be a tilt-rotor aircraft. For example, the eVTOL 10 may include lift-propellers 20 and cruise-propellers 20 which are separated.

The eVTOL 10 includes a battery 31, a distributor 32, a flight control device 40, and EPUs 50. The battery 31, the distributor 32, the flight control device 40, and the EPUs 50 are included in the propulsion system 30. The battery 31 is electrically connected to the EPUs 50. The battery 31 is a power supplying unit that supplies electric power to the EPUs 50, and corresponds to a power supply unit. The battery 31 is a DC voltage source that applies a direct-current voltage to the EPUs 50. The battery 31 has a rechargeable secondary battery. The battery 31 also supplies electric power to the flight control device 40. In addition to or instead of the battery 31, a fuel cell, a generator, or the like may be used as the power supply unit.

The distributor 32 is electrically connected to the battery 31 and the EPUs 50. The distributor 32 distributes the electric power from the battery 31 to the EPUs 50. The electric power distributed to the EPUs 50 by the distributor 32 is drive power for driving the EPUs 50.

The flight control device 40 controls the propulsion system 30. The flight control device 40 performs flight control for causing the eVTOL 10 to fly. The flight control device 40 is communicably connected to the EPUs 50. The flight control device 40 individually controls the EPUs 50. The flight control device 40 controls the EPUs 50 via a control circuit 160 to be described later. The flight control device 40 controls the control circuit 160.

Each of the EPUs 50 is a device for driving the propellers 20 to rotate, and corresponds to a drive device. EPU is an abbreviation of an electric propulsion unit. The EPUs 50 may be referred to as a power drive device or a power drive system. The EPUs 50 are provided individually for each of the propellers 20. The EPUs 50 are arranged on the propellers 20 along their propeller axes. All of the EPUs 50 are fixed on the airframe 11. The EPUs 50 rotatably support the propellers 20. The EPUs 50 are connected to the propellers 20. The propellers 20 are fixed to the airframe 11 via the EPUs 50. When the tilt angles of the propellers 20 are changed, angles of the EPUs 50 are also changed.

The eVTOL 10 includes propulsion devices 15. The propulsion devices 15 are devices for propelling the eVTOL 10. The eVTOL 10 can fly, such as lift, by propulsion of the propulsion devices 15. The propulsion devices 15 includes the propellers 20 and the EPUs 50. In the propulsion devices 15, the EPUs 50 are driven to rotate the propellers 20. The propellers 20 corresponds to a rotary body. The eVTOL 10 flies by rotating the propellers 20. That is, the eVTOL 10 moves by rotating the propellers 20. The eVTOL 10 corresponds to a moving object.

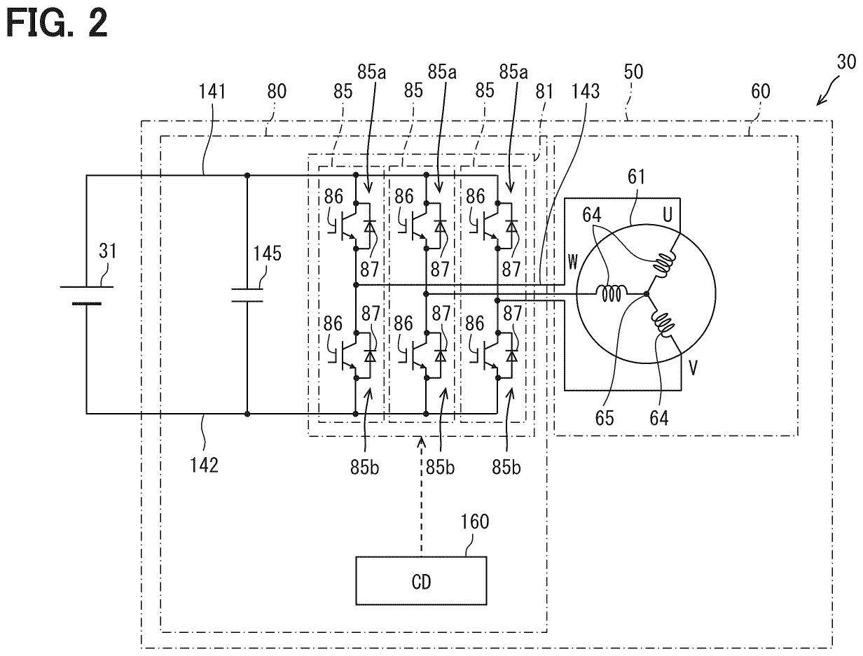

As shown in FIGS. 1 and 2, each of the EPUs 50 includes a motor device 60 and an inverter device 80. The motor device 60 includes a motor 61. The motor device 60 corresponds to a rotary electric machine. The inverter device 80 includes an inverter 81. The motor 61 is electrically connected to the battery 31 via the inverter 81. The motor 61 is driven in response to the electric power supplied from the battery 31 via the inverter 81.

The motor 61 is a multi-phase alternating-current motor. The motor 61 is, for example, a three-phase alternating-current motor, and has a U-phase, a V-phase, and a W-phase. The motor 61 is a movement driving source for moving the moving object, and functions as an electric motor. As the motor 61, for example, a brushless motor is used. The motor 61 functions as a generator during regeneration. The motor 61 includes coils 64 of multiple phases. The coils 64 are windings and form an armature. The coils 64 are provided for each of the U-phase, the V-phase, and the W-phase. In the motor 61, the coils 64 of multiple phases are connected to one another by a neutral point 65.

In FIG. 2, the inverter 81 drives the motor 61 by converting the electric power to be supplied to the motor 61. The inverter 81 converts the electric power supplied to the motor 61 from a direct current to an alternating current. The inverter 81 is a power conversion unit that converts the electric power. The inverter 81 is a multi-phase power conversion unit, and performs power conversion for each of the multiple phases. The inverter 81 is, for example, a three-phase inverter, and performs power conversion for each of the U-phase, the V-phase, and the W-phase. The inverter device 80 may be referred to as a power conversion device.

The inverter device 80 includes a P-line 141 and an N-line 142. The P-line 141 and the N-line 142 electrically connect the battery 31 and the inverter 81. The P-line 141 is electrically connected to a positive electrode of the battery 31. The N-line 142 is electrically connected to a negative electrode of the battery 31. In the battery 31, the positive electrode is an electrode on a high potential side, and the negative electrode is an electrode on a low potential side. The P-line 141 and the N-line 142 are power lines for supplying electric power. The P-line 141 is a power line on the high potential side and may be referred to as a high potential line. The N-line 142 is a power line on the low potential side and may be referred to as a low potential line.

Each of the EPUs 50 includes output lines 143. Each of the output lines 143 is a power line for supplying electric power to the motor 61. The output lines 143 electrically connect the motor 61 and the inverter 81. The output line 143 spans the motor device 60 and the inverter device 80.

The inverter device 80 includes a smoothing capacitor 145. The smoothing capacitor 145 is a capacitor that smooths the direct-current voltage supplied from the battery 31. The smoothing capacitor 145 is connected to the P-line 141 and the N-line 142 between the battery 31 and the inverter 81. The smoothing capacitor 145 is connected in parallel to the inverter 81.

The inverter 81 is a power conversion circuit, for example, a DC-AC conversion circuit. The inverter 81 includes upper and lower arm circuits 85 corresponding to the multiple phases. For example, the inverter 81 includes the upper and lower arm circuits 85 respectively for the U-phase, the V-phase, and the W-phase. Each of the upper and lower arm circuits 85 includes an upper arm 85a and a lower arm 85b. The upper arm 85a and the lower arm 85b are connected in series to the battery 31. The upper arm 85a is connected to the P line 141, and the lower arm 85b is connected to the N line 142.

The output lines 143 are connected to the upper and lower arm circuits 85 for each of the multiple phases. Each of the output lines 143 is connected between the upper arm 85a and the lower arm 85b. The output lines 143 connect the upper and lower arm circuits 85 and the coils 64 for each of the multiple phases. The output lines 143 are connected to ends of the coils 64 on a side opposite to the neutral point 65.

The upper arm 85a and the lower arm 85b each include an arm switch 86 and a diode 87. The arm switch 86 is, for example, a transistor such as an MOSFET. MOSFET is an abbreviation of a metal-oxide-semiconductor field-effect transistor. The arm switch 86 is a switching element, and is capable of converting power by switching. The switch element may be a semi-conductor element such as a power element. The arm switch 86 is a conversion switch for converting electric power.

Each of the EPUs 50 includes the control circuit 160. The control circuit 160 is provided in the inverter device 80. The control circuit 160 controls driving of the inverter 81. The control circuit 160 controls driving of the motor 61 via the inverter 81. The control circuit 160 may be referred to as a motor control unit. In FIG. 2, the control circuit 160 is illustrated as CD.

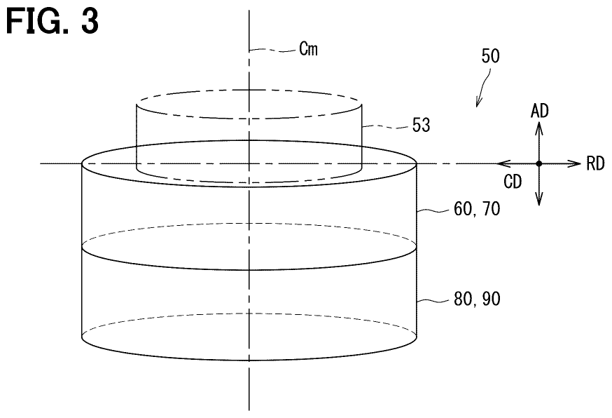

As shown in FIG. 3, in each of the EPUs 50, the motor device 60 and the inverter device 80 are arranged in an axial direction AD along a motor axis Cm. The motor device 60 is provided between a propeller 20 and the inverter device 80 in the axial direction AD. The motor axis Cm is a center axis of the motor 61 and is a virtual line extending linearly. The motor axis Cm corresponds to a rotation axis. The axial direction AD is a direction in which the motor axis Cm extends.

Regarding the motor axis Cm, the axial direction AD, a circumferential direction CD, and a radial direction RD are orthogonal to one another. The circumferential direction CD is a rotation direction of the motor 61. Regarding the radial direction RD, an outer side may be referred to as a radially outer side or an outer peripheral side, and an inner side may be referred to as a radially inner side or an inner peripheral side. The axial direction AD may be referred to as an axial direction.

Each of the EPUs 50 includes a motor housing 70 and an inverter housing 90. The motor housing 70 is included in the motor device 60. The motor housing 70 accommodates the motor 61. The inverter housing 90 is included in the inverter device 80. The inverter housing 90 accommodates the inverter 81. The motor housing 70 and the inverter housing 90 are coupled to each other.

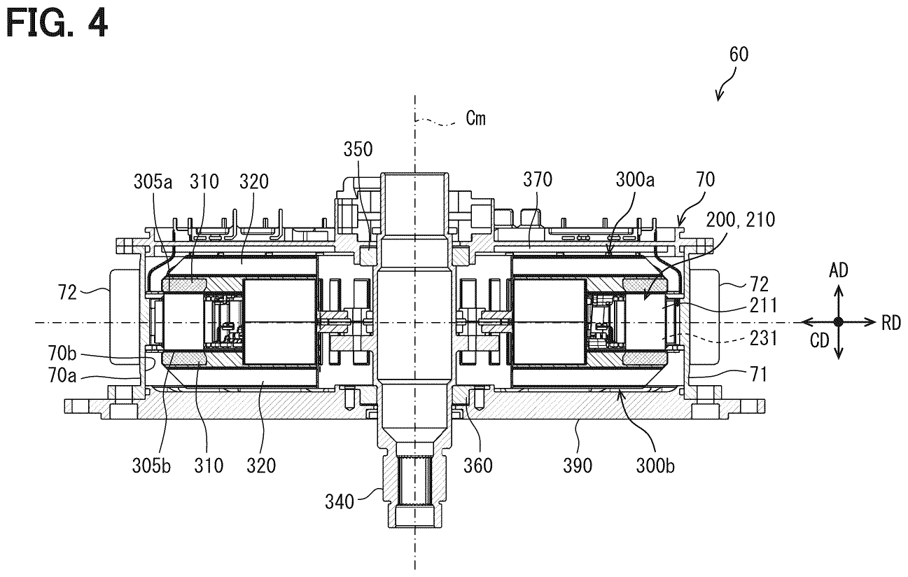

As shown in FIG. 4, the motor housing 70 includes a motor outer peripheral wall 71, a rear frame 370, and a drive frame 390. The motor outer peripheral wall 71 and the frames 370, 390 are made of a metal material or the like and have a thermal conduction property. The motor outer peripheral wall 71 is formed in a tubular shape and extends in the axial direction AD. The frames 370, 390 are formed in a plate shape and extend in a direction orthogonal to the axial direction AD. The rear frame 370 and the drive frame 390 are arranged in the axial direction AD with the motor outer peripheral wall 71 interposed therebetween. The frames 370, 390 are fixed to the motor outer peripheral wall 71 by fasteners such as bolts. FIG. 4 illustrates a vertical cross-section of the motor device 60 taken along the motor axis Cm.

The motor housing 70 has a motor-housing outer surface 70a and a motor-housing inner surface 70b. The motor-housing outer surface 70a is an outer peripheral surface of the motor housing 70 and is included in an outer surface of the motor housing 70. The motor-housing inner surface 70b is an inner peripheral surface of the motor housing 70 and is included in an inner surface of the motor housing 70. The motor-housing outer surface 70a and the motor-housing inner surface 70b are provided by the motor outer peripheral wall 71.

The rear frame 370 covers an inner space of the motor outer peripheral wall 71 and is provided between the motor outer peripheral wall 71 and the inverter device 80. The rear frame 370 is provided such that the motor outer peripheral wall 71 is between the rear frame 370 and the propeller 20. The drive frame 390 covers the inner space of the motor outer peripheral wall 71 and is provided such that the motor outer peripheral wall 71 is between the drive frame 390 and the inverter device 80. The drive frame 390 is provided between the motor outer peripheral wall 71 and the propeller 20.

The motor housing 70 includes motor fins 72. The motor fins 72 are provided on the outer surface of the motor housing 70. For example, the motor fins 72 are provided on the motor-housing outer surface 70a. The motor fins 72 extend outward from the motor outer peripheral wall 71. The motor fins 72 extend in the direction orthogonal to the circumferential direction CD. The motor fins 72 are arranged in the circumferential direction CD. The motor fins 72 are heat dissipation fins that dissipate heat of the motor device 60 to the outside.

The motor 61 includes a stator 200, a first rotor 300a, a second rotor 300b, and a shaft 340. The stator 200 is a stationary element. The stator 200 includes a coil 64. Each of the rotors 300a, 300b is a rotary element. The rotors 300a, 300b rotate relative to the stator 200. The rotors 300a, 300b rotate about the motor axis Cm. The motor axis Cm is a center axis of each of the rotors 300a, 300b. The stator 200 annularly extends in the circumferential direction CD. The motor axis Cm coincides with the center axis of the stator 200.

The motor device 60 is an axial gap rotary electric machine. The motor 61 is an axial gap motor. In the motor 61, the stator 200 and the rotors 300a, 300b are arranged in the axial direction AD along the motor axis Cm. The motor device 60 is a dual-rotor rotary electric machine. The motor 61 is a dual-rotor motor. The first rotor 300a and the second rotor 300b are arranged in the axial direction AD with the stator 200 interposed therebetween. The stator 200 is provided between two rotors, that is, the first rotor 300a and the second rotor 300b. The motor 61 of the present embodiment may be referred to as a double-axial motor.

The shaft 340 supports the rotors 300a, 300b. The shaft 340 rotates around the motor axis Cm together with the rotors 300a, 300b. A center axis of the shaft 340 coincides with the motor axis Cm. The shaft 340 connects the rotors 300a, 300b to the propeller 20.

Each of the rotors 300a, 300b includes magnet portions 310 and a magnet holder 320. The magnet portions 310 are arranged in the circumferential direction CD in each of the rotors 300a, 300b. Each of the magnet portions 310 includes a permanent magnet and forms a magnetic field. In each of the rotors 300a, 300b, the magnet portions 310 generate a magnetic flux. The magnet portions 310 of the first rotor 300a and the magnet portions 310 of the second rotor 300b are arranged in the axial direction AD with the stator 200 interposed therebetween. The magnet holder 320 supports the magnet portions 310. The magnet holder 320 defines outer and inner circumferential ends of the rotors 300a, 300b.

The stator 200 includes a coil unit 210. The coil unit 210 extends in the circumferential direction CD. The coil unit 210 forms the coils 64. The coil unit 210 includes coil portions 211 and stator cores 231. Each of the coil portion 211 is made of an electric wire, such as a rectangular wire, and conducts electricity. The coil portions 211 are wound around the stator cores 231. Each of the coil portions 211 is formed in a tubular shape as a whole and extends in the axial direction AD. Each of the stator cores 231 is an iron core and extends in the axial direction AD. The coil portions 211 and the stator cores 231 are arranged in the circumferential direction CD along the motor-housing inner surface 70b. In the coil unit 210, the coil portions 211 form the coils 64.

The motor 61 includes a first axial gap 305a and a second axial gap 305b. The axial gaps 305a, 305b are gaps between the stator 200 and the rotors 300a, 300b. The axial gaps 305a, 305b include gaps between the magnet portions 310 and the stator core 231. The axial gaps 305a, 305b extend between the stator 200 and the rotors 300a, 300b in a direction perpendicular to the axial direction AD. The first axial gap 305a is a gap between the stator 200 and the first rotor 300a. The second axial gap 305b is a gap between the stator 200 and the second rotor 300b.

The motor device 60 includes a rear bearing 350 and a drive bearing 360. The bearings 350, 360 rotatably support the shaft 340. The bearings 350, 360 annularly extend in the circumferential direction CD. The rear bearing 350 and the drive bearing 360 are arranged in the axial direction AD with the rotors 300a, 300b interposed therebetween. The bearings 350, 360 are fixed to the motor housing 70. The rear bearing 350 is fixed to the rear frame 370. The drive bearing 360 is fixed to the drive frame 390.

The motor housing 70 accommodates the stator 200 and the rotors 300a, 300b. In the motor housing 70, the motor outer peripheral wall 71 covers outer circumferential sides of the stator 200 and the rotors 300a, 300b. The motor housing 70 corresponds to an electric-machine housing. The motor outer peripheral wall 71 corresponds to an electric-machine outer peripheral wall.

The magnet holder 320 is made of resin material or the like, and have electrical insulation properties. For example, the magnet holder 320 is made of CFRP. CFRP is carbon fiber reinforced plastics.

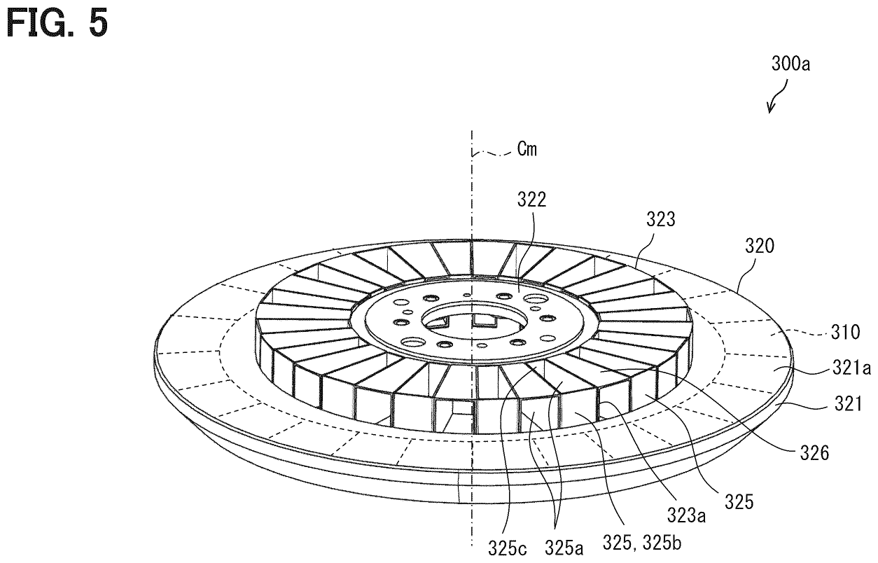

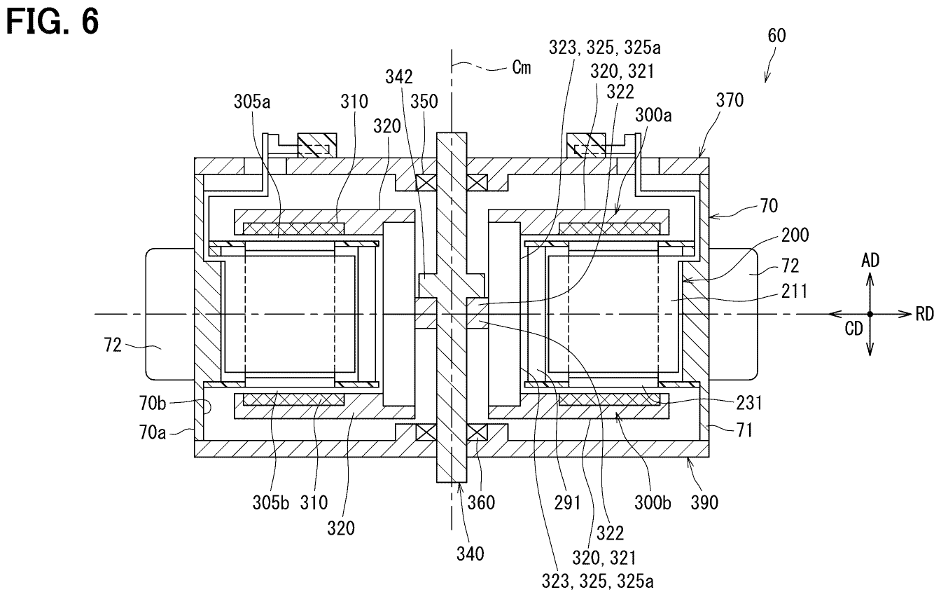

As shown in FIGS. 5 and 6, the magnet holder 320 includes a holder facing portion 321, a holder fixed portion 322, and a holder interposed portion 323. The holder facing portion 321, the holder fixed portion 322, and the holder interposed portion 323 extend annularly in the circumferential direction CD. The holder facing portion 321 forms an outer peripheral end of the magnet holder 320, and is an outer peripheral portion of the magnet holder 320. The holder fixed portion 322 forms an inner peripheral end of the magnet holder 320 and is an inner peripheral portion of the magnet holder 320. The holder interposed portion 323 is provided between the outer peripheral end and the inner peripheral end of the magnet holder 320 in the radial direction RD, and is an intermediate portion of the magnet holder 320.

The holder facing portion 321 faces the stator 200 via the axial gap 305a, 305b. The holder facing portion 321 corresponds to a rotor facing portion. The holder facing portion 321 has a holder facing surface 321a. The holder facing surface 321a is included in an outer surface of the holder facing portion 321. The holder facing surface 321a faces the stator 200 via the axial gap 305a, 305b. At least a part of the holder facing surface 321a defines the axial gap 305a, 305b. The holder facing surface 321a corresponds to a gap facing surface. The holder facing surface 321a extends radially outward and/or radially inward from the axial gap 305a, 305b. The axial gap 305a, 305b corresponds to an axial gap.

The holder facing portion 321 supports the magnet portions 310. In the magnet holder 320, at least a part of each of the magnet portions 310 is embedded in the holder facing portion 321. The magnet portions 310 extend along the holder facing surface 321a inside the holder facing portion 321. The magnet portions 310 are arranged in the circumferential direction CD along the holder facing surface 321a. The magnet portions 310 may be exposed to the axial gap 305a, 305b from the holder facing surface 321a. In this configuration, the holder facing portion 321, the magnet portions 310, or both form the axial gap 305a, 305b.

The holder fixed portion 322 is fixed to the shaft 340. The holder fixed portion 322 corresponds to a rotor fixed portion. The holder fixed portion 322 extends radially outward from the shaft 340. The holder fixed portion 322 is provided at a position spaced apart from the holder facing portion 321 in at least one of the axial direction AD and the circumferential direction CD. For example, the holder fixed portion 322 is provided at a position away from the holder facing portion 321 toward the coil portions 211 in the axial direction AD. The holder fixed portion 322 and the coil portions 211 are arranged in the radial direction RD. The holder fixed portion 322 is located at a position radially inwardly spaced from the coil portions 211.

The holder interposed portion 323 is provided between the holder facing portion 321 and the holder fixed portion 322 in at least one of the axial direction AD and the circumferential direction CD. The holder interposed portion 323 spans from the holder facing portion 321 to the holder fixed portion 322, and connects the holder facing portion 321 to the holder fixed portion 322. The holder interposed portion 323 supports the holder facing portion 321 and the magnet portions 310 while being fixed to the holder fixed portion 322. For example, the holder interposed portion 323 bears load applied to the rotor 300a, 300b. The holder interposed portion 323 is provided radially inward of the axial gap 305a, 305b. The holder interposed portion 323 faces the axial gap 305a, 305b in the radial direction RD.

In this embodiment, the holder interposed portion 323 is arranged with the holder facing portion 321 in both the axial direction AD and the radial direction RD. The holder interposed portion 323 extends toward the frame 370, 390 further than the holder facing surface 321a in the axial direction AD. The holder interposed portion 323 is arranged with the holder fixed portion 322 in the radial direction RD out of the axial direction AD and the radial direction RD.

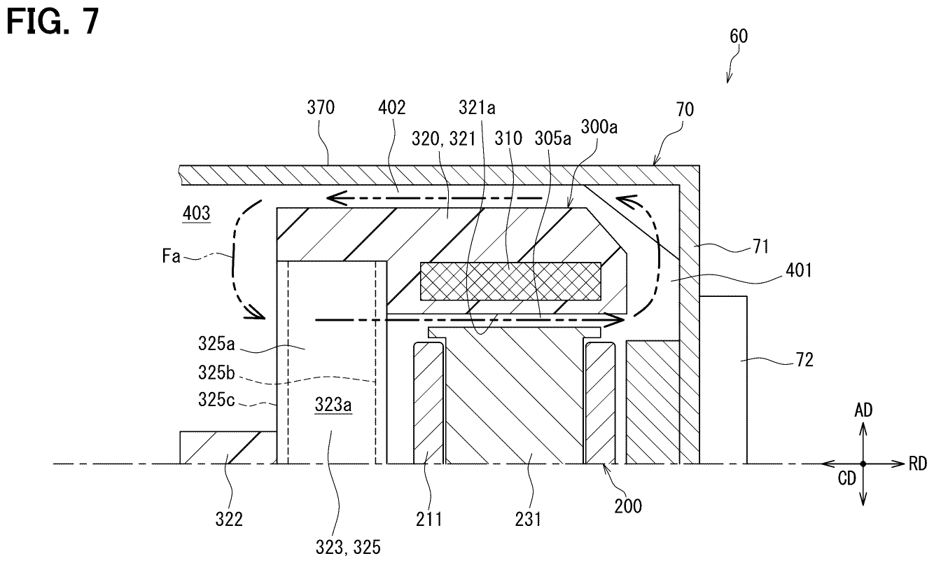

As shown in FIG. 7, an internal space of the motor housing 70 includes an outer peripheral space 401, a frame space 402, and an inner peripheral space 403. The outer peripheral space 401 is a space located radially outward of the rotors 300a, 300b. The outer peripheral space 401 is a space between the rotor 300a, 300b and the motor outer peripheral wall 71 in the radial direction RD. The outer peripheral space 401 is a gap between the holder facing portion 321 and the motor outer peripheral wall 71. The outer peripheral space 401 extends annularly in the circumferential direction CD along the outer circumferential ends of the rotors 300a, 300b. The outer peripheral space 401 is located radially outward of the axial gaps 305a, 305b. The axial gaps 305a, 305b are open radially outward and communicate with the outer peripheral space 401, allowing ventilation to the outer peripheral space 401.

The inner peripheral space 403 is a space located radially inward of the rotors 300a, 300b. The inner peripheral space 403 is a space between the rotor 300a, 300b and the shaft 340 in the radial direction RD. The inner peripheral space 403 extends annularly in the circumferential direction CD along the inner circumferential ends of the rotors 300a, 300b. The inner peripheral space 403 is located radially inward of the axial gaps 305a, 305b.

The frame space 402 is a space on the opposite side of the rotor 300a, 300b from the axial gaps 305a, 305b. The frame space 402 corresponds to an opposite space. The frame space 402 is the space between the rotor 300a, 300b and the frame 370, 390 in the axial direction AD. The frame space 402 is a gap between the holder facing portion 321 and the frame 370, 390. The frame space 402 extends along an inner surface of the frame 370, 390 in a direction perpendicular to the axial direction AD. The frame space 402 communicates with the outer peripheral space 401 and the inner peripheral space 403. The frame space 402 extends in the radial direction RD so as to span between the outer peripheral space 401 and the inner peripheral space 403.

The rotor 300a, 300b divides the inner peripheral space 403 and the axial gap 305a, 305b. For example, the holder interposed portion 323 is provided between the inner peripheral space 403 and the axial gap 305a, 305b in the radial direction RD, and divides the inner peripheral space 403 and the axial gap 305a, 305b.

As shown in FIGS. 6 and 7, the rotor 300a, 300b has holder vent holes 323a. The holder vent holes 323a penetrate the rotor 300a, 300b such that the inner peripheral space 403 communicates with the axial gap 305a, 305b through the holder vent holes 323a. The axial gap 305a, 305b communicates with the frame space 402 via the inner peripheral space 403 and the holder vent holes 323a. The holder vent holes 323a correspond to a rotor through hole. The holder vent holes 323a are provided between the inner peripheral space 403 and the axial gap 305a, 305b in the radial direction RD.

The holder vent holes 323a are formed in the magnet holder 320. For example, the holder vent holes 323a are provided in the holder interposed portion 323. The holder vent holes 323a penetrate the holder interposed portion 323 in the radial direction RD. The holder vent holes 323a face the axial gap 305a, 305b in the radial direction RD. The holder vent holes 323a are arranged in the circumferential direction CD.

As shown in FIGS. 5, 6 and 7, the holder interposed portion 323 includes interposed partition portions 325. The interposed partition portions 325 are provided between the holder facing portion 321 and the holder fixed portion 322 in at least one of the axial direction AD and the circumferential direction CD. The interposed partition portions 325 connect the holder facing portion 321 and the holder fixed portion 322 in a state of spanning from the holder facing portion 321 to the holder fixed portion 322. The interposed partition portions 325 support the holder facing portion 321 and the magnet portions 310 while being fixed to the holder fixed portion 322. For example, the interposed partition portions 325 bear load applied to the rotor 300a, 300b. The interposed partition portions 325 are provided radially inward of the axial gap 305a, 305b. The interposed partition portions 325 are arranged with the axial gap 305a, 305b in the radial direction RD.

In this embodiment, the interposed partition portions 325 are arranged with the holder facing portion 321 in both the axial direction AD and the radial direction RD. The interposed partition portions 325 extend toward the frame 370, 390 further than the holder facing surface 321a. The interposed partition portions 325 is arranged with the holder fixed portion 322 in the radial direction RD out of the axial direction AD and the radial direction RD.

The interposed partition portions 325 are arranged in the circumferential direction CD. The interposed partition portions 325 extend radially in the radial direction RD about the motor axis Cm. A center line passing through the center of each of the interposed partition portions 325 and extending in the radial direction RD passes through the motor axis Cm. The outer peripheral end and the inner peripheral end of the interposed partition portion 325 are aligned in the radial direction RD so as not to be misaligned in the circumferential direction CD. In the holder interposed portions 323, each portion between two interposed partition portions 325 adjacent to each other in the circumferential direction CD defines a holder vent hole 323a. The interposed partition portions 325 divide a space between the holder facing portion 321 and the holder fixed portion 322 into spaces arranged in the circumferential direction CD. The interposed partition portions 325 are included in hole forming portions that form the holder vent holes 323a in the magnet holder 320. The interposed partition portions 325 and the holder vent holes 323a are arranged in the circumferential direction CD.

The holder facing portion 321 and the holder fixed portion 322 extend in the circumferential direction CD so as to bridge the interposed partition portions 325. The holder facing portion 321 and the holder fixed portion 322 connect each two interposed partition portions 325 adjacent to each other in the circumferential direction CD. The holder interposed portion 323 has partition connection portions 326. The partition connection portions 326 connect each two interposed partition portions 325 adjacent to each other in the circumferential direction CD. The partition connection portions 326 are opposed to the holder facing portion 321 with the holder vent holes 323a interposed therebetween in the axial direction AD. The partition connection portions 326 are provided between the holder fixed portion 322 and the coil portions 211 in the radial direction RD.

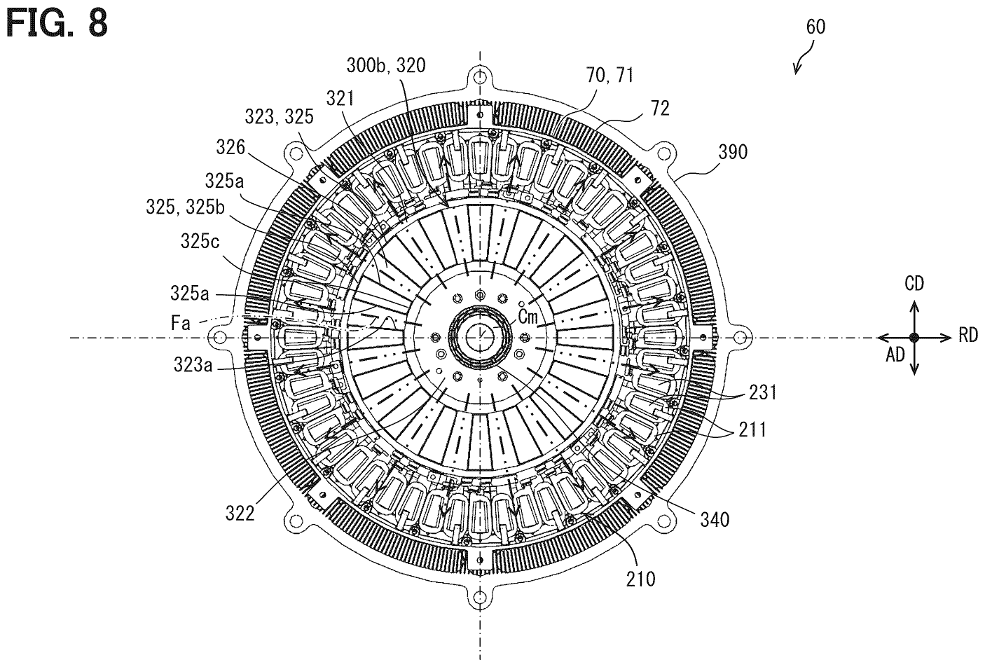

When the rotors 300a, 300b rotate according to driving of the motor device 60, a cooling air flow Fa is generated inside the motor device 60, as shown in FIGS. 7 and 8. In the rotors 300a, 300b, the interposed partition portions 325 function as vanes that generate the cooling air flow Fa. In this way, the interposed partition portions 325 function as vanes, so that the rotors 300a, 300b function like a centrifugal fan such as a sirocco fan. The interposed partition portions 325 send the cooling air flow Fa radially outward to the axial gap 305a, 305b according to rotation of the rotors 300a, 300b. The cooling air flow Fa is a flow of gas, such as air, present inside the motor housing 70. FIG. 8 shows a top view of the motor device 60 with the first rotor 300a removed, when the second rotor 300b is viewed from the stator 200.

As shown in FIG. 7, the cooling air flow Fa generated by the interposed partition portions 325 flows so as to circulate around the holder facing portion 321 in a direction perpendicular to the circumferential direction CD. After the cooling air flow Fa reaches the axial gap 305a, 305b, the cooling air flow Fa passes through the axial gap 305a, 305b and then flows into the outer peripheral space 401. In the axial gap 305a, 305b, heat generated in the stator 200 and the rotor 300a, 300b is released to the outer peripheral space 401 together with the cooling air flow Fa.

The cooling air flow Fa passes from the outer peripheral space 401 through the frame space 402 to reach the inner peripheral space 403 and then returns to the interposed partition portions 325 again. In the outer peripheral space 401 and the frame space 402, the heat of the cooling air flow Fa is dissipated to the outside of the motor device 60 via the motor outer peripheral wall 71 and the frames 370, 390. The cooling air flow Fa returns to the interposed partition portions 325 after being cooled by the motor outer peripheral wall 71 and the frames 370, 390, and then passes through the holder vent holes 323a and flows again toward the axial gaps 305a, 305b. As shown in FIG. 8, the cooling air flow Fa flows from the inner periphery of the holder vent holes 323a toward the outer periphery thereof so as to spread radially.

As described above, in the motor housing 70, the motor outer peripheral wall 71, the frames 370, 390, the motor fins 72, etc. have thermal conductivity. The motor outer peripheral wall 71, the frames 370, 390, the motor fins 72, etc. are formed of, for example, an aluminum alloy. In the motor housing 70, the motor fins 72 are provided on the motor outer peripheral wall 71, so that the heat of the cooling air flow Fa flowing through the outer peripheral space 401 is easily dissipated to the outside through the motor outer peripheral wall 71 and the motor fins 72.

In the motor housing 70, the motor fins 72 increase the strength of the motor outer peripheral wall 71. For example, in a configuration in which the motor fins 72 are not provided on the motor outer peripheral wall 71 unlike this embodiment, it becomes necessary to make the motor outer peripheral wall 71 thicker in order to ensure the strength of the motor outer peripheral wall 71. In contrast, in this embodiment, the strength of the motor outer peripheral wall 71 is ensured by the motor fins 72, so that the motor outer peripheral wall 71 can be made thinner. In other words, the motor fins 72 can improve the rigidity of the motor outer peripheral wall 71 and reduce unnecessary thickness of the motor outer peripheral wall 71. Therefore, the motor fins 72 achieve both a reduction in weight of the motor outer peripheral wall 71 and an improvement in the heat dissipation effect.

As shown in FIGS. 5 and 7, each of the interposed partition portions 325 is formed in a tubular shape and extends in the axial direction AD. For example, each of the interposed partition portions 325 is formed in a rectangular tubular shape. Each of the interposed partition portions 325 has partition ribs 325a, an outer peripheral rib 325b, and an inner peripheral rib 325c. Each of the ribs 325a, 325b, 325c has a plate shape. The partition ribs 325a extend in a direction perpendicular to the circumferential direction CD. The partition ribs 325a are a pair of partition ribs included in each of the interposed partition portions 325. The pair of partition ribs 325a are arranged in the circumferential direction CD while the outer peripheral rib 325b and the inner peripheral rib 325c are interposed between the pair of partition ribs 325a. In each of the interposed partition portions 325, the area between the pair of partition ribs 325a is the interior of each interposed partition portion 325.

The outer peripheral rib 325b and the inner peripheral rib 325c extend in a direction perpendicular to the radial direction RD. The outer peripheral rib 325b and the inner peripheral rib 325c are arranged with each other in the radial direction RD across the partition ribs 325a. The outer peripheral rib 325b is provided radially outward of the inner peripheral rib 325c via the partition ribs 325a. The outer peripheral rib 325b and the inner peripheral rib 325c are bridged by the pair of partition ribs 325a. The outer peripheral rib 325b closes a radially outer side of the interior of the interposed partition portion 325. The inner peripheral rib 325c closes a radially inner side of the interior of the interposed partition portion 325.

The interposed partition portions 325 may or may not be hollow. For example, the interposed partition portions 325 do not necessarily have to contain members that fill the interiors of the interposed partition portions 325, but may contain such a member.

In the holder interposed portion 323, the partition ribs 325a, the outer peripheral ribs 325b, and inner peripheral ribs 325c are arranged in the circumferential direction CD. The partition ribs 325a extend radially in the radial direction RD about the motor axis Cm. A center line passing through the center of each of the partition ribs 325a and extending in the radial direction RD passes through the motor axis Cm. The outer peripheral end and the inner peripheral end of each of the partition ribs 325a are aligned in the radial direction RD so as not to be misaligned in the circumferential direction CD.

When the rotors 300a, 300b rotate, the partition ribs 325a are included in the portion of the interposed partition portions 325 that generate the cooling air flow Fa. That is, the partition ribs 325a function as at least a part of the vanes as the rotors 300a, 300b rotate. The partition ribs 325a corresponds to a vane rib. The outer peripheral ribs 325b and the inner peripheral ribs 325c connect the pair of partition ribs 325a and correspond to connecting ribs.

According to the present embodiment described above, the interposed partition portions 325 are provided radially inward of the axial gap 305a, 305b, and send the cooling air flow Fa toward the axial gaps 305a, 305b as the rotors 300a, 300b rotate. In this configuration, when the rotors 300a, 300b rotate as the motor device 60 is driven, the cooling air flow Fa sent from the interposed partition portions 325 passes through the axial gap 305a, 305b. In this case, heat generated in the stator 200 and the rotors 300a, 300b is likely to be released to the outer periphery of the axial gaps 305a, 305b together with the cooling air flow Fa. Therefore, the interposed partition portions 325, which are parts of the rotors 300a, 300b, can prevent heat from being trapped in the axial gaps 305a, 305b. Therefore, a cooling effect of the motor device 60 can be enhanced.

In this embodiment, since the interposed partition portions 325 of the rotors 300a, 300b function as vanes capable of blowing air, there is no need to provide a dedicated fan for blowing air inside the motor device 60. Therefore, since there is no dedicated fan inside the motor device 60, increases in the weight, manufacturing costs, and size of the motor device 60 can be reduced.

In the motor device 60, heat generated in the axial gaps 305a, 305b is likely to be the greatest. That is, the axial gaps 305a, 305b tend to be the areas that generate the greatest heat in the motor device 60. In contrast, in this embodiment, the axial gaps 305a, 305b serve as an air passage for the cooling air flow Fa generated by the interposed partition portions 325, so that the heat dissipation effect from the axial gaps 305a, 305b can be improved.

Moreover, since the interposed partition portions 325 are provided radially inward of the axial gaps 305a, 305b, the cooling air flow Fa generated by the interposed partition portions 325 can be efficiently caused to flow into the axial gaps 305a, 305b. In other words, inside the motor housing 70, an air flow that does not pass through the axial gaps 305a, 305b is unlikely to be generated. This air flow tends to become a wasteful wind that does not contribute to releasing heat from the axial gaps 305a, 305b. By allowing the cooling air flow Fa to flow efficiently in this manner, windage loss inside the motor housing 70 can be reduced. Therefore, temperature increases in the in-tubular air and in-tubular components housed in the motor housing 70 can be reduced.

According to this embodiment, the interposed partition portions 325 are arranged with the axial gaps 305a, 305b in the radial direction RD. In this configuration, the cooling air flow Fa generated by the interposed partition portions 325 can reach the axial gaps 305a, 305b without flowing in the axial direction AD. Thus, the cooling air flow Fa can easily pass through the axial gaps 305a, 305b. In addition, the cooling air flow Fa is less likely to be disturbed until it reaches the axial gaps 305a, 305b. Therefore, the cooling air flow Fa can flow efficiently through the axial gaps 305a, 305b.

According to this embodiment, the holder vent holes 323a penetrate the rotors 300a, 300b such that the axial gaps 305a, 305b communicate with the frame space 402 through the holder vent holes 323a. In this configuration, the cooling air flow Fa generated by the interposed partition portion 325 passes through the axial gaps 305a, 305b, and then easily returns to the rotors 300a, 300b from the frame space 402 through the holder vent holes 323a. Therefore, the holder vent holes 323a can make the cooling air flow Fa easily circulate inside the motor housing 70. By circulating the cooling air flow Fa in this manner, the cooling air flow Fa can flow efficiently inside the motor housing 70.

According to this embodiment, in the rotors 300a, 300b, the interposed partition portions 325 are arranged with the holder vent holes 323a in the circumferential direction CD. Therefore, the interposed partition portions 325 and the holder vent holes 323a enable the rotors 300a, 300b to function as a centrifugal fan.

According to this embodiment, the interposed partition portions 325 connect the holder facing portion 321 and the holder fixed portion 322. In this configuration, the interposed partition portions 325 structurally support the holder facing portion 321 in the rotors 300a, 300b. In this manner, the interposed partition portions 325 that structurally constitute the rotors 300a, 300b can be utilized as vanes that generate the cooling air flow Fa. That is, a function of generating the cooling air flow Fa by pressurizing gas can be added to the interposed partition portions 325 that supports the magnet portions 310 in the rotors 300a, 300b. Therefore, there is no need to provide a dedicated portion for generating the cooling air flow Fa in the rotors 300a, 300b. Therefore, the rotors 300a, 300b can be made smaller and lighter.

According to this embodiment, the interposed partition portions 325 are provided between the holder facing portion 321 and the holder fixed portion 322 in at least one of the axial direction AD. In this configuration, the cooling air flow Fa that is generated by the interposed partition portions 325 and flows in the radial direction RD is unlikely to be blocked by the holder facing portion 321 or the holder fixed portion 322. In this manner, the cooling air flow Fa can made to flow efficiently by the positional relationship between the interposed partition portions 325, the holder facing portion 321, and the holder fixed portion 322.

According to this embodiment, each of the interposed partition portions 325 extends in a tubular shape in the axial direction AD. In this configuration, each of the interposed partition portions 325 can be made hollow and can accommodate a lightweight member inside the interposed partition portions 325. By reducing the weight of the interposed partition portions 325 in this manner, the weight of the rotors 300a, 300b can be reduced.

According to this embodiment, in each of the interposed partition portions 325, two partition ribs 325a adjacent to each other in the circumferential direction CD are connected by an outer peripheral rib 325b and an inner peripheral rib 325c. In this configuration, the support strength with which the partition ribs 325a support the holder facing portion 321 can be increased by the outer peripheral rib 325b and the inner peripheral rib 325c. Therefore, in a configuration in which each of the interposed partition portions 325 including the partition ribs 325a is utilized as a vane, the strength of each of the interposed partition portions 325 can be increased by the outer peripheral rib 325b and the inner peripheral rib 325c.

According to the present embodiment, the motor device 60 drives the eVTOL 10 to fly. In this configuration, when the eVTOL 10 is flying due to the drive of motor device 60, the interposed partition portions 325 can suppress reduction in cooling effects in the motor device 60. In this way, the cooling effect of the motor device 60 can be improved by the interposed partition portions 325, thereby improving the safety of the eVTOL 10.

### Second Embodiment

In the first embodiment, the interposed partition portions 325 extend toward the holder facing portion 321 beyond the axial gaps 305a, 305b. In contrast to this, in the second embodiment, the interposed partition portions 325 does not extend beyond the axial gaps 305a, 305b toward the holder facing portion 321. Configurations, operations, and effects not specifically described in the second embodiment are the same as those in the above-described first embodiment. In the second embodiment, differences from the above-described first embodiment will be mainly described.

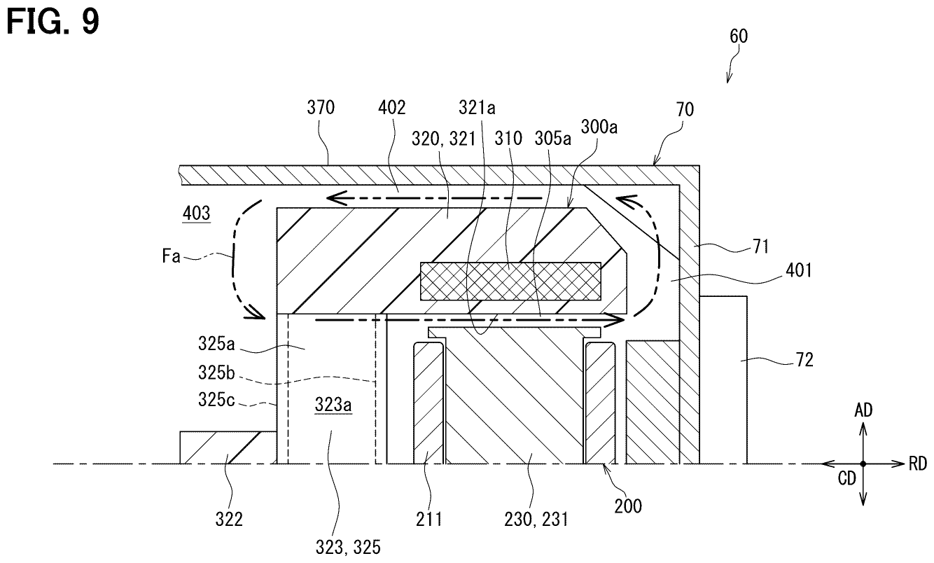

As shown in FIG. 9, a holder facing surface 321a extends radially inward from the axial gaps 305a, 305b. The holder facing surface 321a extends in the radial direction RD to span between an inner peripheral end and an outer peripheral end of the holder facing portion 321. The holder interposed portion 323 and the interposed partition portion 325 extend from the holder facing surface 321a in the axial direction AD toward the coil portions 211. That is, the holder interposed portion 323 and the interposed partition portion 325 do not extend further toward the frames 370, 390 than the holder facing surface 321a in the axial direction AD.

In each of the rotors 300a, 300b, the interposed partition portions 325 and the axial gap 305a, 305b are arranged in the radial direction RD along the same plane, that is, the holder facing surface 321a. Moreover, the holder vent holes 323a extend in the axial direction AD from the holder facing surface 321a. Therefore, the holder vent holes 323a and the axial gap 305a, 305b are arranged in the radial direction RD along the same plane, the holder facing surface 321a, and communicate with each other. The cooling air flow Fa generated by rotation of the rotors 300a, 300b flows along the holder facing surface 321a and passes through both the holder vent holes 323a and the axial gap 305a, 305b. Therefore, the cooling air flow Fa flowing along the holder facing surface 321a is less likely to be disturbed between the holder vent holes 323a and the axial gap 305a, 305b.

For example, unlike this embodiment, a configuration is assumed in which a step surface extending from the holder facing surface 321a exists between the holder vent holes 323a and the axial gap 305a, 305b. In this configuration, the cooling air flow Fa that has passed through the holder vent holes 323a passes through the step surface, which tends to cause turbulence in the cooling air flow Fa. Therefore, there is a concern that the efficient flow of the cooling air flow Fa passing through the axial gap 305a, 305b may be disturbed.

According to this embodiment, the interposed partition portions 325 extend in the axial direction AD from the holder facing surface 321a. In this configuration, the cooling air flow Fa generated by the interposed partition portions 325 can reach the axial gap 305a, 305b by flowing along the holder facing surface 321a. This can prevent the cooling air flow Fa from becoming turbulent before it reaches from the interposed partition portions 325 to the axial gap 305a, 305b. In other words, it is possible to reduce windage loss due to refraction of the cooling air flow Fa before it reaches the axial gap 305a, 305b through the interposed partition portions 325.

### Third Embodiment

In the first embodiment, each interposed partition portion 325 extends in the radial direction RD so that an outer peripheral end and an inner peripheral end of each interposed partition portion 325 are not misaligned in the circumferential direction CD. In contrast to this, in the third embodiment, each interposed partition portion 325 extends in the radial direction RD with its outer peripheral end and its inner peripheral end misaligned in the circumferential direction CD. Configurations, operations, and effects not specifically described in the third embodiment are the same as those in the above-described first embodiment. In the third embodiment, differences from the above-described first embodiment will be mainly described.

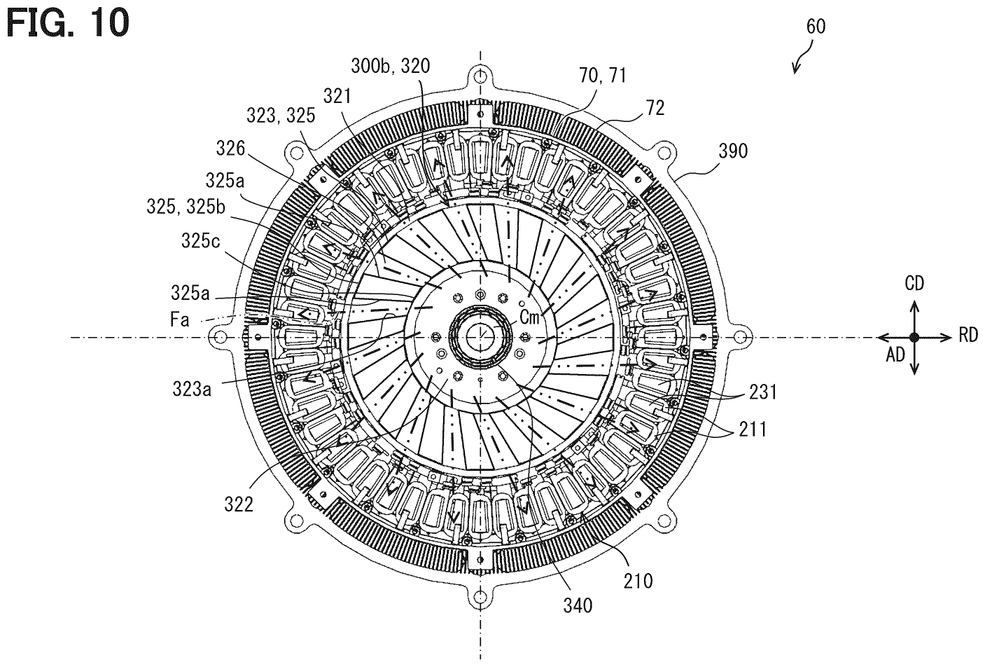

As shown in FIG. 10, the interposed partition portions 325 extend in the radial direction RD while being inclined in the circumferential direction CD. In each of the interposed partition portions 325, an outer peripheral end and an inner peripheral end are provided at positions shifted from each other in the circumferential direction CD. The center line of each interposed partition portion 325 passes through a position spaced apart in the radial direction RD from the motor axis Cm. Like the interposed partition portions 325, the partition ribs 325a extend in the radial direction RD while being inclined in the circumferential direction CD. In each of the interposed partition portions 325, an outer peripheral end and an inner peripheral end of each partition rib 325a are provided at positions shifted from each other in the circumferential direction CD. The center line of each partition rib 325a passes through a position spaced apart in the radial direction RD from the motor axis Cm.

In this embodiment, the interposed partition portions 325 and the partition ribs 325a extend in the radial direction RD while being inclined in the circumferential direction CD, so that the rotors 300a, 300b function like a turbofan, which is a type of centrifugal fan. Furthermore, since the interposed partition portions 325 and the partition ribs 325a are inclined in the circumferential direction CD, the length of the interposed partition portions 325 and the partition ribs 325a can be increased by the amount of inclination. By enlarging vanes in this manner, the air blowing capacity of the interposed partition portions 325 can be increased.

### OTHER EMBODIMENTS

The disclosure of this specification is not limited to the illustrated embodiment. The disclosure encompasses the illustrated embodiments and variations based on the embodiments by those skilled in the art. For example, the disclosure is not limited to the combinations of components and elements shown in the embodiments, and various modifications and implementations can be performed. The disclosure may be implemented in various combinations. The disclosure may have additional portions that may be added to the embodiments. The disclosure encompasses the embodiments in which parts and elements are omitted. The disclosure encompasses replacement or combination of the components and elements between one embodiment and another. The technical scope disclosed in the present disclosure is not limited to the above-described embodiments. It should be understood that some disclosed technical ranges are indicated by description of claims, and includes every modification within the equivalent meaning and the scope of description of claims.

In each of the above-described embodiments, the interposed partition portions 325 may be provided in any manner as long as they are disposed radially inward of the axial gap 305a, 305b. For example, the interposed partition portions 325 may be provided at positions away from the axial gap 305a, 305b toward the coil portions 211 in the axial direction AD. The interposed partition portions 325 may be arranged with the holder facing portion 321 in the radial direction RD out of the axial direction AD and the radial direction RD. The interposed partition portions 325 may be arranged with the holder fixed portion 322 in the axial direction AD.

In each of the above-described embodiments, the vanes such as the interposed partition portions 325 does not necessarily have to support the rotor facing portion such as the holder facing portion 321. In other words, the vanes do not need to support the load applied to the rotors 300a, 300b. For example, the interposed partition portions 325 may protrude from the holder facing portion 321, the holder fixed portion 322, and the holder interposed portion 323 in the axial direction AD or the radial direction RD.

In each of the above-described embodiments, the holder vent holes 323a do not have to be arranged with the interposed partition portions 325 in the circumferential direction CD. Furthermore, as long as the interposed partition portions 325 are provided in the magnet holder 320, the holder vent holes 323a may not be provided in the magnet holder 320.

In each of the above-described embodiments, the interposed partition portions 325 may have any structure as long as they function as the vanes. For example, each of the interposed partition portions 325 may not be formed in a tubular shape. For example, each of the interposed partition portions 325 may include only the partition ribs 325a among the partition ribs 325a, the outer peripheral rib 325b, and the inner peripheral rib 325c. In this configuration, the partition ribs 325a functions as the vanes.

In each of the embodiments described above, the motor 61 may not be a dual-rotor motor. For example, the motor 61 may be a single-rotor motor.

In each of the embodiments described above, the flight vehicle on which the motor device 60 is mounted may not be the vertical take-off and landing aircraft as long as being of an electric type. For example, the flight vehicle may be a flight vehicle capable of taking off and landing while gliding, as an example of the electric aircraft. The flight vehicle may be a rotorcraft, or a fixed-wing aircraft. The flight vehicle may be an unmanned flight vehicle carrying no person.

In each of the embodiments described above, the moving object on which the motor device 60 is mounted may not be a flight vehicle as long as the moving object is movable by rotation of the rotary body. For example, the moving object may be a vehicle, a ship, a construction machine, or an agricultural machine. For example, when the moving object is a vehicle, a construction machine, or the like, the rotary body is a movement-wheel or the like, and an output shaft portion is an axle or the like. When the moving object is a ship, the rotary body is a propulsion-screw propeller or the like, and the output shaft portion is a propeller shaft or the like. Furthermore, the motor device 60 may be provided in various types of stationary equipment.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A rotary electric machine configured to be driven by a supply of electric power, the rotary electric machine comprising:
a stator;
a rotor configured to rotate about a rotation axis, and facing the stator through an axial gap in an axial direction in which the rotation axis extends;
an electric-machine housing accommodating the stator and the rotor, and including
an electric-machine outer peripheral wall that covers outer circumferential sides of the stator and the rotor,
an opposite space on an opposite side of the rotor from the axial gap, and
an outer peripheral space between the rotor and the electric-machine outer peripheral wall, wherein the axial gap communicates with the opposite space through the outer peripheral space; and
a rotor through hole communicating with the outer peripheral space through the axial gap in the radial direction, and penetrating the rotor such that the opposite space communicates with the axial gap through the rotor through hole, wherein
the rotor includes vanes provided inward of the axial gap in a radial direction of the rotation axis, and configured to send gas toward the axial gap according to rotation of the rotor.

2. The rotary electric machine according to claim 1, wherein
the vane and the axial gap are arranged in the radial direction.

3. The rotary electric machine according to claim 1, wherein
the vanes are arranged in the rotor through hole in a circumferential direction of the rotation axis.

4. The rotary electric machine according to claim 1, further comprising
a shaft supporting the rotor and configured to rotate with the rotor about the rotation axis, wherein
the rotor includes a rotor facing portion facing the stator through the axial gap, and a rotor fixed portion fixed to the shaft, and
the vanes connect the rotor facing portion and the rotor fixed portion.

5. The rotary electric machine according to claim 4, wherein
the rotor fixed portion is separated from the rotor facing portion in the axial direction by the axial gap, and
the vanes are provided between the rotor facing portion and the rotor fixed portion in the axial direction.

6. The rotary electric machine according to claim 5, wherein
each of the vanes extends in a tubular shape in the axial direction and bridges between the rotor facing portion and the rotor fixed portion.

7. The rotary electric machine according to claim 4, wherein
the vanes include vane ribs connecting the rotor facing portion and the rotor fixed portion, extending in plate shapes in directions perpendicular to a circumferential direction of the rotation axis, being arranged in the circumferential direction, and configured to send gas toward the axial gap according to rotation of the rotor, and
a connecting rib extending in a plate shape in a direction perpendicular to the radial direction and connecting two vane ribs adjacent to each other in the circumferential direction.

8. The rotary electric machine according to claim 1, wherein
the rotor includes a gap facing surface extending in a direction perpendicular to the axial direction, facing the stator through the axial gap, and defining the axial gap, and
the vanes are provided radially inward of the axial gap and extend in the axial direction from the gap facing surface.

9. The rotary electric machine according to claim 1, wherein
the rotary electric machine is provided in a flight vehicle and drives the flight vehicle to fly.

10. The rotary electric machine according to claim 1, wherein
the vanes are configured to generate the gas to flow through the axial gap, the outer peripheral space, the opposite space and the rotor through hole and then return to the vanes.
